(19) United States
(12) Patent Application Publication
(10) Pub. No.: US 2019/0199425 A1
(43) Pub. Date: Jun. 27, 2019

(54) INTERFERENCE REDUCTION FROM TERRESTRIAL BASE STATION TRANSMISSION TO FIXED SATELLITE SERVICE

(71) Applicant: Telcom Ventures, LLC, Miami, FL (US)

(72) Inventors: Rajendra Singh, Indian Creek Village, FL (US); George Ronald Olexa, Gainesville, GA (US)

(21) Appl. No.: 16/210,626

(22) Filed: Dec. 5, 2018

Related U.S. Application Data
(60) Provisional application No. 62/609,457, filed on Dec. 22, 2017.

(51) Int. Cl. H04B 7/155; H04B 7/185; H04W 72/04

(52) U.S. Cl. CPC H04B 7/15564; H04B 7/18578; H04W 72/0446; H04B 7/18515; H04W 72/0453; H04B 7/18528

(57) ABSTRACT

Methods of allocating C-band resources are provided. The method includes determining first C-band resources used for a Fixed Satellite Service (FSS), and determining an allocation of second C-band resources for a terrestrial Broadband Wireless Access (BWA) network based on both channel state information associated with the terrestrial BWA network and the first C-band resources used for the FSS. Related wireless electronic devices, and computer program products are also provided.

### CROSS REFERENCE TO RELATED APPLICATION

The present application claims the benefit of U.S. Provisional Patent Application Ser. No. 62/609,457, filed Dec. 22, 2017, the disclosure of which is hereby incorporated herein it its entirety by reference.

### BACKGROUND

With the increased demand for Broadband Wireless Access (BWA) networks, there is a significant interest in sharing the same radio spectrum for BWA and Fixed Satellite Service (FSS). However, many FSS receivers are located in the same geographical areas as the areas with an increased demand for BWA. Signals received by FSS ground receivers travel long distances from geostationary communication satellites and thus may have weak signal strength upon arrival at the FSS ground receivers. These received FSS signals may be weak and may benefit from significant protection from BWA signals from nearby terrestrial base stations and user equipments (UE) transmitters. Interference from terrestrial base station BWA transmitters to the FSS satellite receivers is thus of concern.

### BRIEF DESCRIPTION OF THE DRAWINGS

FIG. 1 is a schematic diagram illustrating a geographical area that is served by Fixed Satellite Service (FSS) satellites and by a Broadband Wireless Access (BWA) network, according to some embodiments of the present inventive concepts.

FIG. 2 and FIG. 3 illustrate FSS and BWA network transmissions, according to some embodiments of the present inventive concepts.

FIG. 4A illustrates adjacent channel power ratio, according to some embodiments of the present inventive concepts.

FIG. 4B and FIG. 5 illustrate FSS and BWA network transmissions, according to some embodiments of the present inventive concepts.

FIG. 6 illustrates communications in a BWA network, according to some embodiments of the present inventive concepts.

FIG. 7 is a block diagram of a wireless electronic device, according to some embodiments of the present inventive concepts.

FIG. 8 is a block diagram of an example processor and memory that may be used in accordance with embodiments of the present inventive concepts.

FIGS. 9 to 17 are flowcharts illustrating operations for reducing interference at a FSS receiver, according to some embodiments of the present inventive concepts.

### DETAILED DESCRIPTION

Example embodiments of the present inventive concepts now will be described with reference to the accompanying drawings. The present inventive concepts may, however, be embodied in a variety of different forms and should not be construed as limited to the embodiments set forth herein. Rather, these embodiments are provided so that this disclosure will be thorough and complete, and will fully convey the scope of the present inventive concepts to those skilled in the art. In the drawings, like designations refer to like elements.

Satellite downlink transmission of broadcast television occurs in the C-band (3.7 GHz to 4.2 GHz) from Fixed Satellite Service (FSS) satellites while uplink transmission may be between 5.925 to 6.425 GHz. A typical satellite may have multiple C-band transponders, with each transponder having one or more channels occupying a total bandwidth up to 72 MHz. A terrestrial FSS receiver may receive signals from various channels transmitted by some, but not all of the C-band transponders. Although the example embodiment provided herein are in the context of C-band FSS receivers, the techniques described herein may apply to any frequency bands used by FSS satellites and/or FSS receivers, such as Ku-band FSS satellites and/or FSS receivers. A geostationary satellite may be at a distance of more than 22,000 miles from a FSS receiver. Due to the distance traveled by the signals from the C-band satellite transponders, the signal strength may be relatively weak and thus may be susceptible to interference from terrestrial communication networks such as Broadband Wireless Access (BWA) networks. Base stations (BS) and User Equipments (UE) of BWA networks may be in close proximity (i.e. within a few miles) to the FSS receivers. Various embodiments described herein arise from the recognition that terrestrial co-channel use of satellite frequencies may interfere with the satellite signals received at the satellite receive station. MIMO interference reduction techniques are described herein in a real-world environment to reduce interference to FSS receivers.

Modern communication systems utilize Orthogonal Frequency Division Modulation (OFDM) and other advanced waveforms to create signals from a base station (BS) targeted to User Equipments (UEs). The base station may enhance the signal to a given UE while reducing the signal strength in other areas not near the given UE, by using directional techniques such as beam forming and/or solutions such as massive multiple-input and multiple-output (MIMO) systems. Channel State information (CSI) may be used to configure MIMO and/or massive MIMO systems. The term “channel state information” (CSI) may be used to refer to channel characteristics between a base station and a UE in a BWA network. The term “satellite channel status” (SCS) may be used to refer to channel characteristics between a satellite and the FSS receiver.

In wireless communications, channel state information, may refer to known channel properties of a communication link. This information describes how a signal propagates from the transmitter to the receiver and represents the combined effect of, for example, scattering, fading, and power decay with distance. Techniques such as channel estimation may be used to characterize the aforementioned effects. The CSI makes it possible to adapt transmissions to current channel conditions, which may be used for achieving reliable communication with high data rates in multi-antenna systems. In some cases, the CSI may be measured and/or estimated at the FSS receiver and fed back to the base station transmitter in order to facilitate transmitter adjustments such as channel selection, transmit power, etc. The CSI may be used by a base station or a UE in a BWA network to improve the quality of communication. In other words, signal transmission parameters between BWA network elements such as a base station and a UE may be changed to reduce interference to an FSS receiver's operation.

Depending on the channel state information associated with a given FSS site, a base station may make computations that will use one or more multi-element antennas at the base station to enhance or reduce the radio signal strength directionally. In some embodiments, multiple base stations may coordinate with one another to directionally send signals to UEs. Interference may be mitigated in systems where base stations may be in different locations but still cover similar and/or partially overlapping geographical areas.

A Massive MIMO beamforming solution using a feedback loop between monitor stations located near or at the FSS receiver site and/or one or more BWA base stations may reduce interference between FSS signals and BWA signals. Monitor stations may include passive devices, modified UEs, or custom built receivers that listen for and/or receive FSS transmissions and/or BWA network transmissions between UEs and base stations. In some embodiments, a UE of the BWA network may perform the functionality of the monitor station. Monitor stations may be located after the FSS antenna, or if that is not possible, within meters of near or at the FSS receiver (i.e., in close geographic proximity to the FSS receiver). In some embodiments, monitor stations may be configured to listen for and/or receive C-band signals, but may not transmit C-band signals. The monitor stations may facilitate a second feedback loop that detects signals before or after the FSS receiver antenna and provides information about interfering signals that have been seen by the monitor station to the BS controller. This second feedback loop may work in conjunction with the first feedback loop or may work independently from the first feedback loop. The second feedback loop may include a receiver/detector monitor located before or after the FSS antenna, and may be designed to specifically look for unique characteristics of the BS or UE waveform in order to discriminate from the FSS signal, or take advantage of a gap in transmission, blanking interval, or unused spectrum located between multi-carrier transponders in the FSS downlink transmissions. A gap or blanking interval in the downlink transmissions can occur due to the nature of the application or by operator design without significantly affecting the performance of the FSS. C-band signals for FSS may include services such as broadcast television that may have gaps or blanking intervals periodically or aperiodically between segments of data. The monitor stations, may send the CSI or the SCS to the core network directly to one or more of the base stations in order to effect the feedback loop and allow the offending BS to take corrective action.

The UE may also contribute to a raised interference level at the FSS site. Monitor stations may monitor base station transmissions or may monitor UE transmissions. In the case of UE caused interference, the UE may not be able to modify antenna patterns, so the feedback loop would need to inform the base station to no longer allocate frequencies falling within the channel receive bandwidth of the FSS receiver to the offending UE. This could include shifting operation between the UE and the base station to an in band channel with FSS or to an out of band channel, if available.

Additionally, a terrestrial FSS receiver (i.e., ground station) may provide information to the core network, the base station, or the base station controller regarding polarization, modulation, channel on/off status, and/or antenna pattern information, which may be used by the base station controller to further reduce interference potential. This information may be sent back to the base station controller via monitoring stations via a wired facility and/or on an out-of-band channel.

In some embodiments, CSI or SCS may be sent to the core network or to the base station controller from monitor stations during a FSS downlink transmission. Monitor stations may send this information infrequently, such that the disruption to FSS transmissions may occur infrequently, thus causing minor signal interference/degradation. In some embodiments, monitor receivers may send information infrequently, such as when interference that is causing an increase in Bit Error Rate (BER) is detected. FSS receivers may take advantage of Forward Error Correction (FEC) methods to overcome any minor degradation of FSS downlinks. FSS operation may also assign a small portion of the FSS frequency band, such as a FSS sub-band, to enable feedback to the base station controller. The FSS sub-band may be used on a continuous basis to provide a feedback loop for the CSI or SCS to the base station controller and reduce/minimize interference to the FSS receiver from a BWA base station.

Communication between UEs and the base station may interfere with the signal received by FSS signals. In some embodiments, in order to mitigate interference from a UE to BS at the FSS receiver, the state information from the UE may be transmitted in guard bands between the downlink channels used by the C-band transponders to communicate with the terrestrial FSS receiver. Use of the guard bands by the UE to transmit state information may significantly reduce interference with the FSS receiver.

Various embodiments will now be discussed in further detail with reference to the figures.

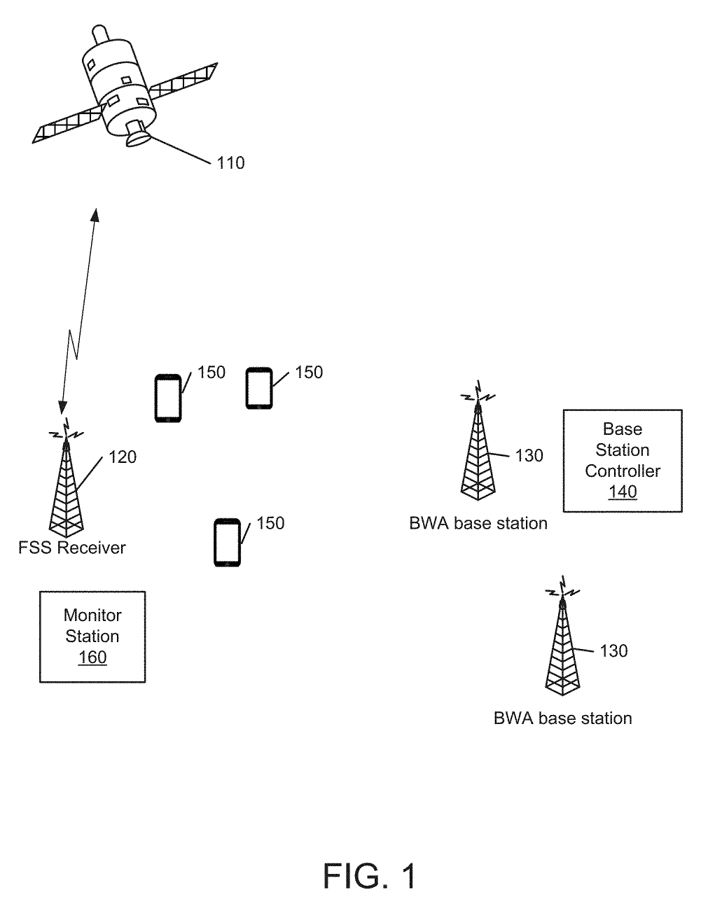

FIG. 1 is a schematic diagram illustrating a geographical area that is served by FSS satellites and by a BWA network. Referring now to FIG. 1, a satellite 110 may communicate with a terrestrial FSS receiver 120 using suitable satellite communication frequencies such as the C-band. The FSS receiver 120 may be in the same geographic area as a BWA network including elements such as a base station 130, a base station controller 140, and UEs 150. Communication between the base station 130 and one or more of the UEs 150 may use the C-band and thus the BWA network communications may interfere with satellite downlink signals received at the FSS receiver 120. Various base stations 130 may coordinate usage of the C-band spectrum in overlapping base station geographical coverage areas. A monitor station 160 may be placed in close proximity to the FSS receiver 120 in order to effectively listen to BWA communications received by the FSS receiver 120. The monitor station 160 may be a passive listening device to detect BWA signals falling within the FSS receiver's operating range. The monitor station 160 may provide information regarding FSS signals to elements of the BWA network wirelessly in a different band from the C-band or by a wireline connection. In order to allocate C-band resources in a terrestrial network such as a BWA network, first C-band resources used for a Fixed Satellite Service (FSS) may be determined and an allocation of second C-band resources for a terrestrial Broadband Wireless Access (BWA) network may be determined based on both (i) channel state information associated with the terrestrial BWA network and (ii) the first C-band resources used for the FSS.

The user equipment 150 may be (or may be a part of) one of various types of wireless electronic user devices, including mobile/cell phones, as well as wireless user devices without phone capabilities. For example, the user equipment 150 may be a smartphone, a laptop computer, a tablet computer, or any other portable, wireless electronic device with communications capability. The user equipment 150 can be located anywhere inside a geographical area serviced by a base station 130.

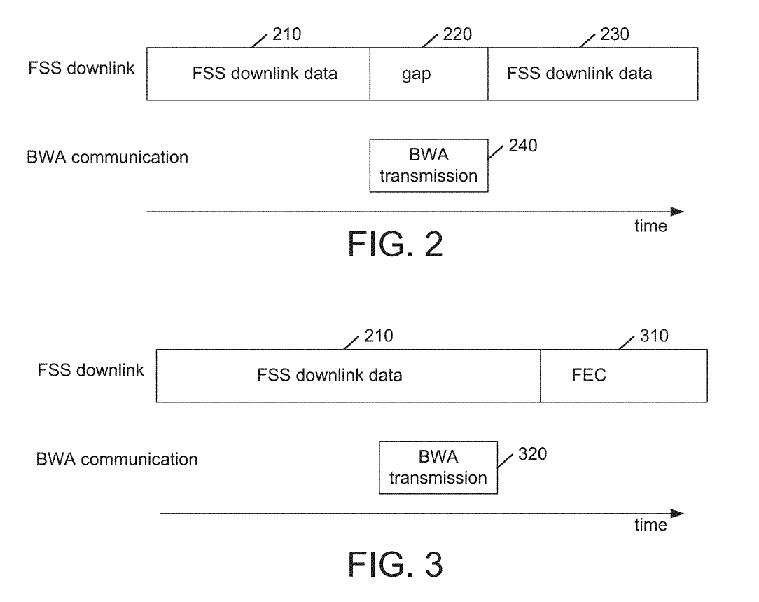

Referring now to FIG. 2, FSS downlink data may be transmitted from the satellite 110 to the FSS receiver 120 of FIG. 1. FSS downlink data may include broadcast television or other types of data. The FSS downlink data may have gaps or blanking intervals between segments of data. These gaps or blanking intervals may occur periodically or aperiodically. The BWA network may send co-channel communications during time periods that coincide with these gaps in the FSS downlink data. Elements in the BWA network such as base station 130, UE 150, or monitor station 160 of FIG. 1 may detect these time gaps in the FSS downlink data. In some embodiments, the FSS receiver 120 or an FSS network controller may be aware of the characteristics of the FSS downlink data and may provide this information to one or more elements in the BWA network. Such coordination between the FSS network and the BWA network may allow collaboration for effective reuse of the C-band frequencies for both satellite communications and terrestrial communications. The BWA network elements may thus transmit and/or receive BWA transmissions during the time gaps in the FSS downlink data.

In some embodiments, coordination may not be possible between the FSS network and the BWA network since it may be difficult to update network topology changes in either network. However, in some embodiments, coordination between the FSS network and the BWA network may not be necessary for both networks to coexist using the C-band. Referring now to FIG. 3, FSS downlink data may be transmitted from the satellite 110 to the FSS receiver 120 of FIG. 1. However, the BWA network may send BWA transmissions during the same time or during overlapping times with the FSS downlink data. These BWA transmissions may occur between the UE 150 and the base station 130, between the UE 150 and the base station controller 140, between the base station controller 140 and the UE 150, and/or between the base station controller 140 and the base station 130 in either the uplink or downlink directions between the various network elements. The BWA transmissions may be of higher power than the FSS downlink data received at the FSS receiver and thus may corrupt the FSS downlink data. However, the BWA transmissions may occur infrequently such that a small portion of the FSS downlink data is corrupted by the BWA transmissions. Thus the FSS downlink may use Forward Error Correction (FEC) to correct errors in the FSS downlink data. FEC is a technique used for controlling errors in data transmission over unreliable or noisy communication channels. The FSS downlink data may be encoded to include some redundancy by using an error correcting code (ECC) such as a Hamming code. The redundancy in the error correcting code allows the FSS receiver to detect a limited number of errors that may occur in the FSS downlink data and/or correct these errors without retransmission. The use of FEC by the FSS receiver 120 may thus improve the reliability of the FSS downlink.

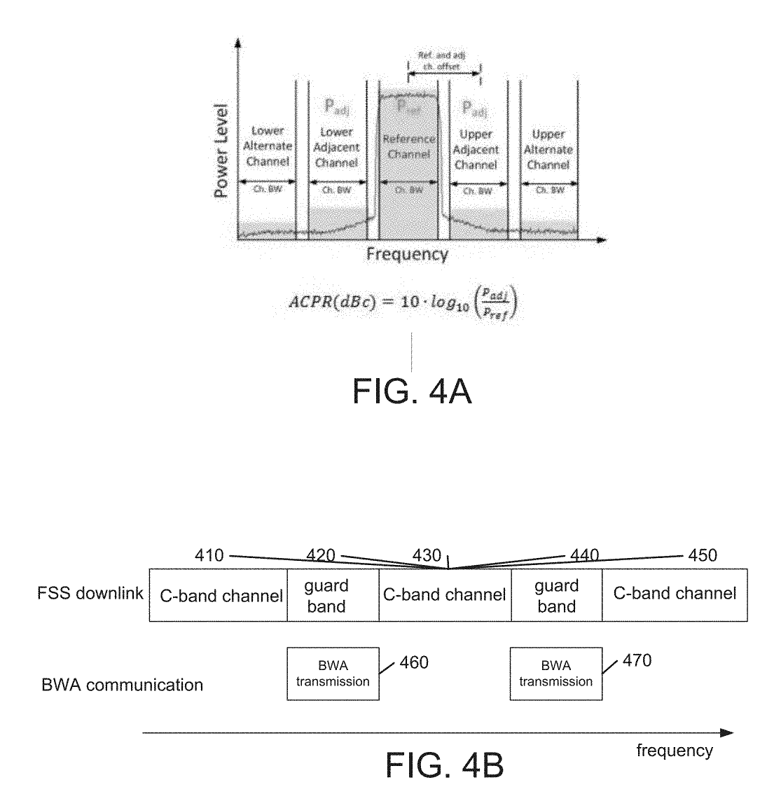

The carriers associated with C-band channels may have some spectral energy in adjacent channels. FIG. 4A illustrate an adjacent channel power ratio. Referring now to FIG. 4A, the adjacent channel power ratio (ACPR) may be determined based on the equation ACPR=10*log₁₀(P_{adj}/P_{ref}) where P_{adj} is the power in the adjacent channel and P_{ref} is the reference power in a given channel. Guard bands between adjacent channels may be present to reduce the spectral energy that bleeds into the adjacent channels. However, these guards band may have fairly low spectral energy with respect to the carrier in a given C-band channel. Additionally, out-of-band (OoB) emission limits for satellite channels may be specified for the guard bands. RF carriers, such as those used in satellite communication may not have an immediate falloff at the edge of the carrier. The carrier's spectral energy may gently decay over about 10% of the bandwidth (i.e. 10% on each side of the carrier). In a Phase Shift Keying System (PSK) based system like FSS, a 30 MHz carrier would have the majority of the carrier's power in 24 MHz. This carrier would be operating in the center of the 30 MHz channel allocation. The 3 MHz guard band on either side of the carrier would give the carrier sufficient spectrum so it rolls off to noise level by the time it reaches the neighboring channel. Depending upon the carrier bandwidth, the guard band bandwidth may be different.

In some embodiments, the BWA network may use guard bands between C-band channels for BWA communications. In some embodiments, it may be understood that the guard band may be a part of the spectrum where a roll off of the signal at the edge of a channel has occurred. A guard band may be at an edge of the allocated spectrum or between adjacent carriers in a band. Referring now to FIG. 4B, the C-band spectrum is partitioned into C-band channels used for satellite communications. Adjacent C-band channels may have guard bands that include C-band frequencies that are not used for satellite communication and have very low spectral energy from satellite downlink communications in the various C-band channels. The BWA network may use these guard bands for BWA transmissions between various BWA network elements such as base station 130, base station controller 140, UEs 150, and/or monitor station 160 of FIG. 1. The BWA transmissions on the C-band guard bands thus would have very low interference with the FSS downlink received by the FSS receiver.

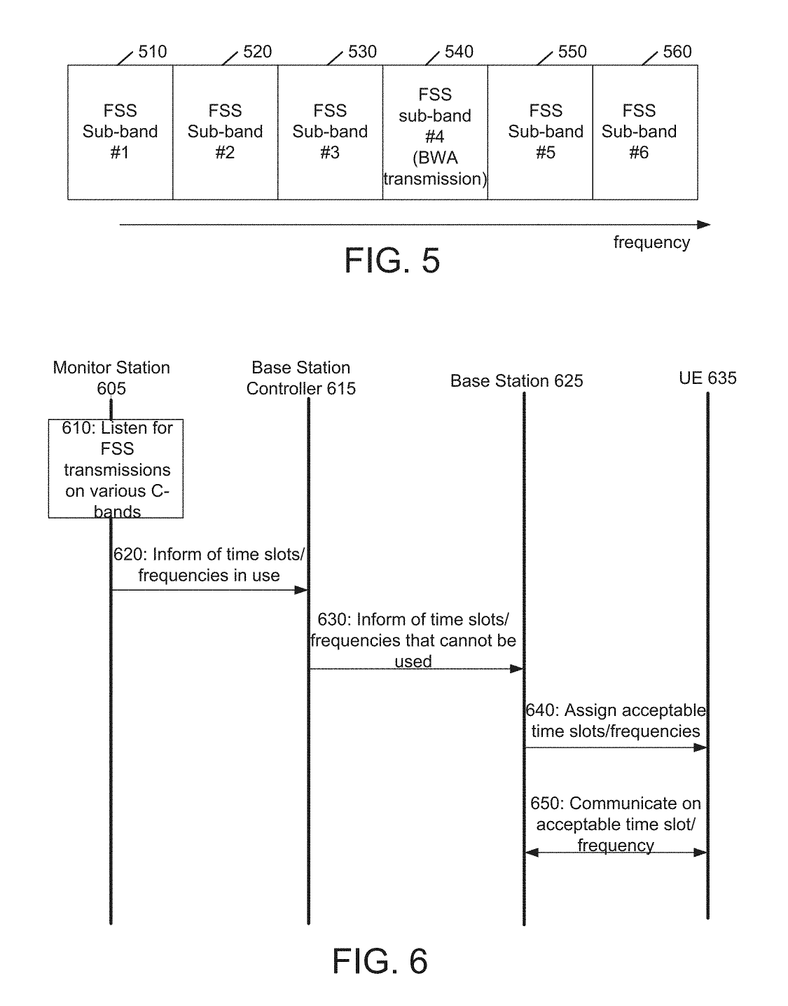

In some embodiments, the C-band channel usage may be coordinated between the FSS and the BWA network. The FSS C-band spectrum may be divided into FSS sub-bands. A coordinated effort between FSS operators and BWA network operators may allow specific FSS sub-bands to be allocated for use for terrestrial communications in the BWA network. As such, these terrestrially allocated FSS sub-bands would not be used in the FSS downlink. Referring now to FIG. 5, in an example embodiment, FSS sub-band #4 may be allocated and used for BWA transmissions by various BWA network elements such as base station 130, base station controller 140, UEs 150, and/or monitor station 160 of FIG. 1. Changes for FSS sub-band usage may be coordinated between FSS operators and BWA network operators as additional satellite or BWA users come online or leave the networks.

Referring now to FIG. 6, monitor station 605 may correspond to monitor station 160 of FIG. 1, base station controller 615 may correspond to base station controller 140 of FIG. 1, base station 625 may correspond to base station 130 of FIG. 1, and UE 635 may correspond to UE 150 of FIG. 1. Monitor station 605 may be in close proximity to, co-located with, or integrated with the FSS receiver 120 of FIG. 1. Monitor station 605 may include a receiver configured to listen for activity on C-band frequencies, with emphasis on FSS downlink signals, at 610. The monitor station 605 may discern C-band frequencies, channels, sub-bands, and time slots in use by C-band downlink communications to the FSS receiver 120 of FIG. 1. The monitor station 605 may provide this information to one or more elements in the BWA network, at 620. The base station controller 615 may inform the base station 625 of resources such as times/frequencies that cannot be used by the BWA network, at 630. The base station 625 may assign acceptable time slots and/or frequencies to the UE 635 for use in communication within the BWA network, at 640. The base station 625 and the UE 635 may communicate via these assigned time slots and/or frequencies, at 650.

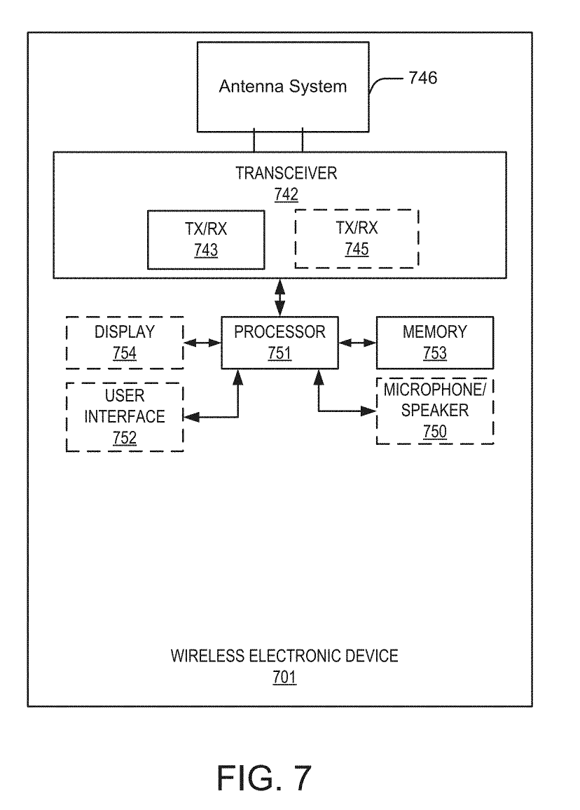

Referring to FIG. 7, a block diagram is provided of a wireless electronic device which may correspond to one more of various BWA network elements such as base station 130, base station controller 140, UEs 150, and/or monitor station 160 of FIG. 1, according to some embodiments. As illustrated in FIG. 7, a wireless electronic device 701 may include an antenna system 746, a transceiver 742, a processor (e.g., processor circuit) 751, and a memory 753. Moreover, the wireless electronic device 701 may optionally include a display 754, a user interface 752, and/or a microphone/speaker 750.

A transmitter portion of the transceiver 742 may convert information, which is to be transmitted by the wireless electronic device 701, into electromagnetic signals suitable for radio communications. A receiver portion of the transceiver 742 may demodulate electromagnetic signals, which are received by the wireless electronic device 701. The transceiver 742 may include transmit/receive circuitry (TX/RX) that provides separate communication paths for supplying/receiving RF signals to different radiating elements of the antenna system 746 via their respective RF feeds. Accordingly, when the antenna system 746 includes two active antenna elements, the transceiver 742 may include two transmit/receive circuits 743, 745 connected to different ones of the antenna elements via the respective RF feeds. For example, the transmit/receive circuit 743 may be connected to a Wi-Fi antenna or a close/short-range (e.g., a Near-Field Communication (NFC) or BLUETOOTH®) antenna, whereas the transmit/receive circuit 745 may be connected to a cellular antenna or a 3G, 4G, LTE, or 5G antenna. Moreover, the antenna system 746/transceiver 742 may include a GPS receiver.

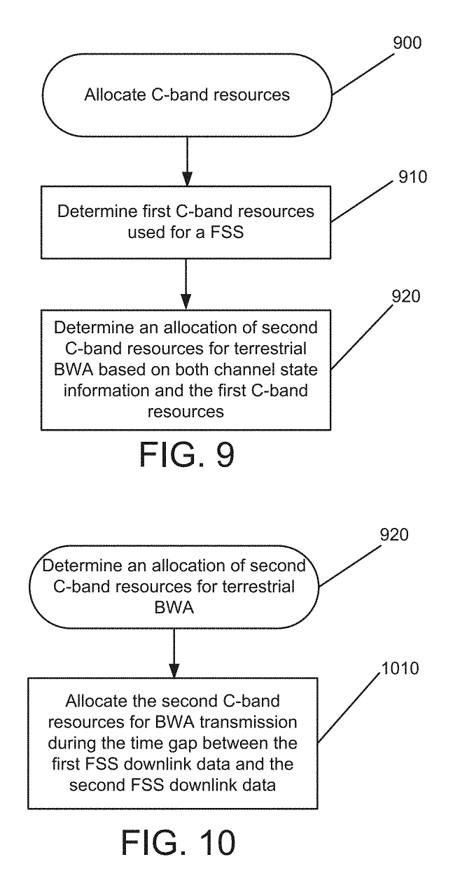

Referring still to FIG. 7, the memory 753 can store computer program instructions that, when executed by the processor circuit 751, carry out operations of the wireless electronic device 701. In some embodiments, the memory 753 can be a non-transitory computer readable storage medium including computer readable program code therein that when executed by the processor 751 causes the processor 751 to perform a method described herein. As an example, the memory 753 can store the resident application described herein, which can perform the operations illustrated in various blocks of the flow charts of FIGS. 9 to 17. The memory 753 can be, for example, a non-volatile memory, such as a flash memory, that retains the stored data while power is removed from the memory 753.

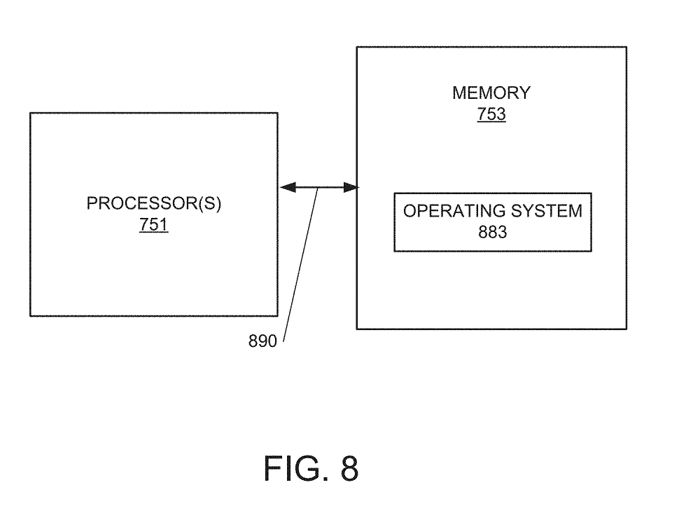

FIG. 8 illustrates a block diagram of an example processor 751 and memory 753 that may be used in accordance with various embodiments of the present inventive concepts. The processor 751 communicates with the memory 753 via an address/data bus 890. The processor 751 may be, for example, a commercially available or custom microprocessor. Moreover, the processor 751 may include multiple processors. The memory 753 is representative of the overall hierarchy of memory devices containing the software and data used to implement various functions as described herein. The memory 753 may include, but is not limited to, the following types of devices: cache, ROM, PROM, EPROM, EEPROM, flash, Static RAM (SRAM), and Dynamic RAM (DRAM).

Referring to FIG. 8, the memory 753 may hold various categories of software and data, such as an operating system 883. The processor 751 and memory 753 may be part of a wireless electronic device 701. Accordingly, the operating system 883 can control operations of the wireless electronic device 701. In particular, the operating system 883 may manage the resources of the wireless electronic device 701 and may coordinate execution of various programs (e.g., a resident application described herein) by the processor 751.

FIGS. 9 to 17 are flowcharts of operations for reducing interference at a FSS receiver 120. Referring to FIG. 9, C-band resources are allocated, at block 900. First C-band resources may be determined as being used for a FSS, at block 910. An allocation of second C-band resources for terrestrial BWA may be determined, based on both channel state information and the first C-band resources, at block 920.

FIG. 10 is flowchart of operations for reducing interference at a FSS receiver 130 that may correspond to FIG. 2. Referring to FIG. 10, an allocation of the second C-band resources for terrestrial BWA may be determined, at block 920. The second C-band resources for the terrestrial BWA network for BWA transmission during a time gap 220 between the first FSS downlink data 210 and the second FSS downlink data 230 may be allocated, at block 1010.

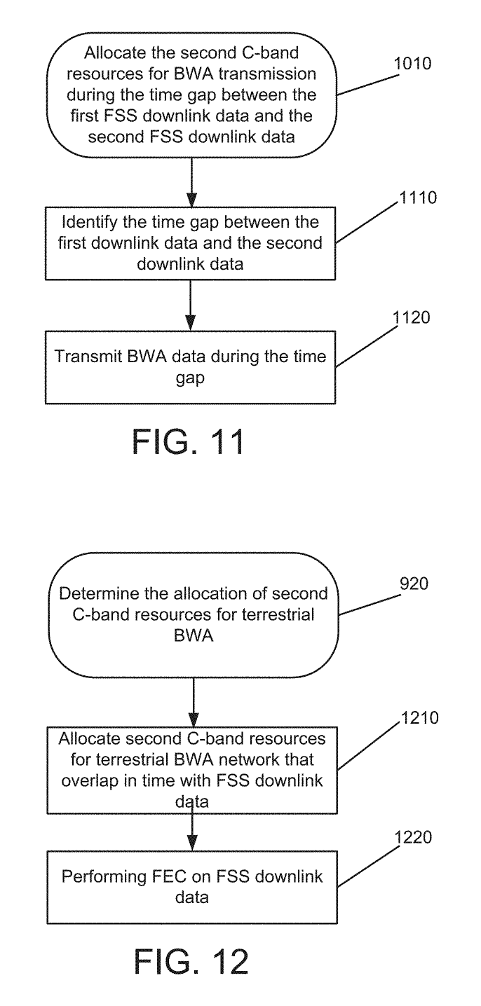

FIG. 11 is flowchart of operations for reducing interference at a FSS receiver that may correspond to FIG. 2. Referring to FIG. 11, the time gap 220 between the first downlink data 210 and the second downlink data 230 may be identified, at block 1110. BWA data may be transmitted during the time gap between elements of the BWA network such as base station 130, UE 150, or monitor station 160 of FIG. 1, at block 1120.

FIG. 12 is flowchart of operations for reducing interference at a FSS receiver 120 that may correspond to FIG. 3. Referring to FIG. 12, an allocation of the second C-band resources for terrestrial BWA may be determined, based on the first C-band resources used by the FSS, at block 920. The second C-band resources for the terrestrial BWA network may be allocated such that they overlap in time with the FSS downlink data, at block 1210. This allocation of overlapping C-band resources may interfere with signals received by the FSS receiver, causing errors in the FSS downlink data 210. Forward Error Correction (FEC) may be performed on the FSS downlink data 210 to reduce errors and/or improve the reliability of the data by transmitting a Forward Error Correction code 310, at block 1220.

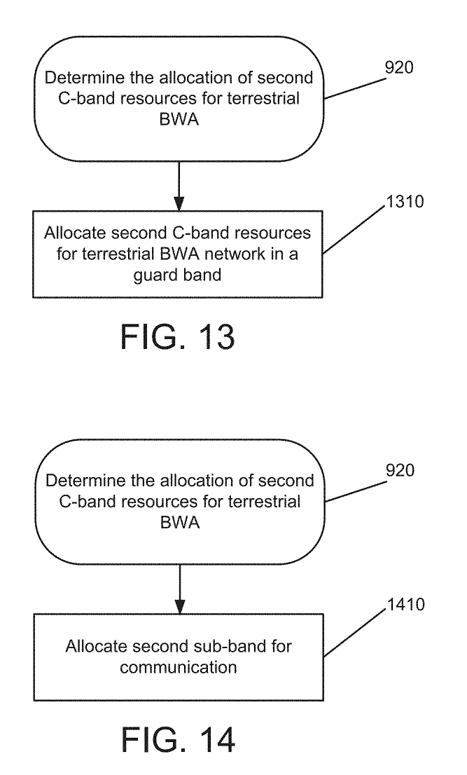

FIG. 13 is flowchart of operations for reducing interference at a FSS receiver 120 that may correspond to FIG. 4B. Referring to FIG. 13, an allocation of the second C-band resources for terrestrial BWA may be determined, based on the first C-band resources used by the FSS, at block 920. The first C-band resources used for the FSS may include FSS downlink data distributed across a first C-band channel 410, a second C-band channel 430 and/or a third C-band channel 450. The second C-band resources for the terrestrial BWA network may be allocated in a guard band 420 that is between the first C-band channel 410 and the second C-band channel 430, at block 1310. BWA transmission 460 by a base station 130 and/or a user equipment (UE) 150 using the second C-band resources for the terrestrial BWA network that were allocated in the guard band 420 may not interfere with the first C-band channel 410 and/or the second C-band channel 430. Similarly, BWA transmission 470 may be sent during a second guard band 440 that occurs between the second C-band channel 430 and the third C-band channel 450.

FIG. 14 is flowchart of operations for reducing interference at a FSS receiver 120 that may correspond to FIG. 5. The first C-band resources used for the FSS may include a plurality of first FSS sub-bands 510, 520, 530, 550, 560 used by the FSS. Referring to FIG. 14, an allocation of the second C-band resources for terrestrial BWA may be determined, based on the first C-band resources, at block 920. A second FSS sub-band may be allocated for communication between a base station 130 and/or a user equipment (UE) 150 in the terrestrial BWA network, at block 1410. The second FSS sub-band 540 may be different from sub-bands of the first FSS sub-bands. Allocating the second FSS sub-band 540 is performed by a base station controller 140 or by the base station 130.

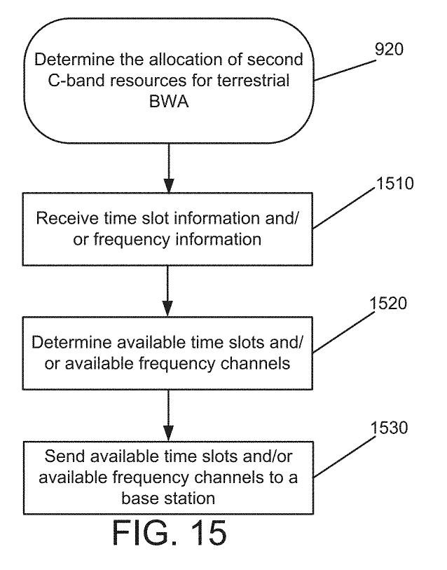

FIG. 15 is flowchart of operations for reducing interference at a FSS receiver 120 that may correspond to FIG. 6. The first C-band resources used for the FSS may include a plurality of first FSS sub-bands used by the FSS. Referring to FIG. 15, an allocation of the second C-band resources for terrestrial BWA may be determined, based on the first C-band resources, at block 920. Time slot information and/or frequency information associated with transmissions in the terrestrial BWA network may be received at a base station controller 140 from a monitor station 160, at block 1510. Available time slots and/or available frequency channels based on the time slot information and/or the frequency information may be determined, at block 1520. Information associated with the available time slots and/or available frequency channels may be sent to a base station 130 in the terrestrial BWA network for assignment for communication with one or more user equipments (UEs) 150, at block 1530.

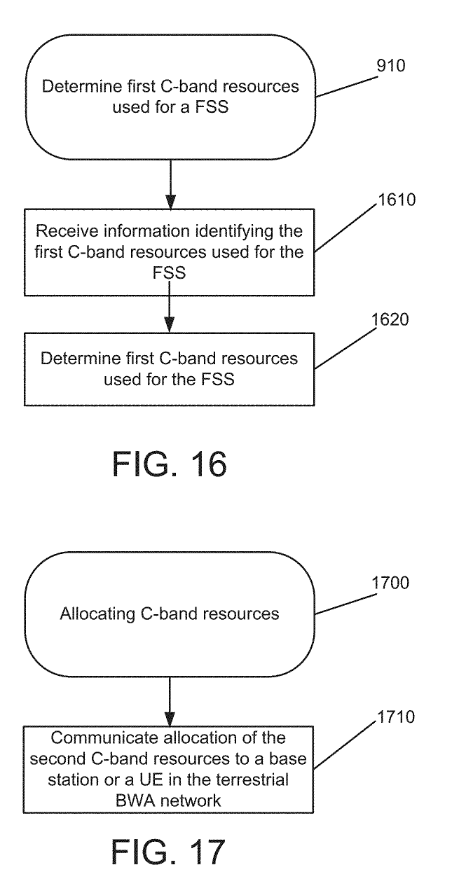

FIG. 16 is flowchart of operations for reducing interference at a FSS receiver 120. First C-band resources used for a FSS may be determined, at block 910. Information identifying the first C-band resources used for the FSS may be received by the base station controller 140 or the base station 130, at block 1610. The first C-band resources used for the FSS may be determined based on the information identifying the first C-band resources used for FSS, at block 1620.

FIG. 17 is flowchart of operations for reducing interference at a FSS receiver 120. C-band resources may be allocated at block 1700. The allocation of the second C-band resources for the terrestrial BWA network may be communicated to a base station 130 and/or a user equipment (UE) 150 in the terrestrial BWA network for use in BWA communication between the base station 130 and the UE 150, at block 1710.

A variety of different embodiments of the present inventive concepts have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments of the present inventive concepts described herein, and of the manner and process of making and using them, and shall support claims to any such combination or subcombination.

It will be understood that when an element is referred to as being “connected,” “coupled,” or “responsive” to another element, it can be directly connected, coupled, or responsive to the other element or intervening elements may be present. Furthermore, “connected,” “coupled,” or “responsive” as used herein may include wirelessly connected, coupled, or responsive.

The terminology used herein is for the purpose of describing particular embodiments of the present inventive concepts only and is not intended to be limiting of the present inventive concepts. As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. The symbol “/” is also used as a shorthand notation for “and/or.”

Unless otherwise defined, all terms (including technical and scientific terms) used herein have the same meaning as commonly understood by one of ordinary skill in the art to which the present inventive concepts belong. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that although the terms “first” and “second” may be used herein to describe various elements, these elements should not be limited by these terms. These terms are only used to distinguish one element from another element. Thus, a first element could be termed a second element, and similarly, a second element may be termed a first element without departing from the teachings of the present inventive concepts.

A variety of different embodiments of the present inventive concepts have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments of the present inventive concepts described herein, and of the manner and process of making and using them, and shall support claims to any such combination or subcombination.

In the drawings and specification, there have been disclosed example embodiments of the present inventive concepts. Although specific terms are employed, they are used in a generic and descriptive sense only and not for purposes of limitation, the scope of the present inventive concepts being defined by the following claims.

What is claimed is:

1. A method of allocating C-band resources, the method comprising:
determining first C-band resources used for a Fixed Satellite Service (FSS); and
determining an allocation of second C-band resources for a terrestrial Broadband Wireless Access (BWA) network based on both channel state information associated with the terrestrial BWA network and the first C-band resources used for the FSS.

2. The method of claim 1, wherein the first C-band resources used for the FSS comprise a first FSS downlink data and a second FSS downlink data separated by a time gap between the first FSS downlink data and the second FSS downlink data, and wherein the determining the allocation of the second C-band resources for the terrestrial BWA network comprises:
allocating the second C-band resources for the terrestrial BWA network for BWA transmission during the time gap between the first FSS downlink data and the second FSS downlink data.

3. The method of claim 2, wherein the BWA transmission during the time gap between the first FSS downlink data and the second FSS downlink data does not interfere with the first FSS downlink data and does not interfere with the second FSS downlink data.

4. The method of claim 2, wherein the allocating the second C-band resources for the terrestrial BWA network comprises:
identifying the time gap between the first FSS downlink data and the second FSS downlink data; and
transmitting BWA data during the time gap that was identified.

5. The method of claim 4, wherein the identifying the time gap and/or the transmitting BWA data are performed by a base station and/or a user equipment (UE).

6. The method of claim 1, wherein the first C-band resources used for the FSS comprise FSS downlink data, and wherein the determining the allocation of the second C-band resources for the terrestrial BWA network comprises:
allocating the second C-band resources for the terrestrial BWA network that overlap in time with the FSS downlink data.

7. The method of claim 6, further comprising:
performing, by a FSS receiver, Forward Error Correction (FEC) on the FSS downlink data to correct errors in the FSS downlink data caused by non-FSS transmissions on the second C-band resources that overlap in time with the FSS downlink data.

8. The method of claim 1, further comprising:
performing, by a FSS receiver, Forward Error Correction (FEC) on FSS downlink data to correct errors in the FSS downlink data caused by non-FSS transmissions on the second C-band resources that overlap in time with the FSS downlink data.

9. The method of claim 1, wherein the first C-band resources used for the FSS comprise FSS downlink data distributed across a first C-band channel and a second C-band channel, and wherein the determining the allocation of the second C-band resources for the terrestrial BWA network comprises:
allocating the second C-band resources for the terrestrial BWA network in a guard band that is between the first C-band channel and the second C-band channel.

10. The method of claim 9, wherein a transmission by a base station and/or a user equipment (UE) in the second C-band resources for the terrestrial BWA network that were allocated in the guard band does not interfere with the first C-band channel and/or the second C-band channel.

11. The method of claim 1, wherein the first C-band resources used for the FSS comprise a plurality of first FSS sub-bands used by the FSS, wherein the determining the allocation of the second C-band resources for the terrestrial BWA network comprises:
allocating a second FSS sub-band for communication between a base station and/or a user equipment (UE) in the terrestrial BWA network, and
wherein the second FSS sub-band is different from ones of the plurality of the first FSS sub-bands.

12. The method of claim 11, wherein the allocating the second FSS sub-band is performed by a base station controller.

13. The method of claim 1, wherein the determining the allocation of the second C-band resources for the terrestrial BWA network comprises:
receiving, from a monitor station, time slot information and/or frequency information associated with transmissions in the terrestrial BWA network;
determining available time slots and/or available frequency channels based on the time slot information and/or the frequency information; and
sending information associated with the available time slots and/or available frequency channels to a base station in the terrestrial BWA network for assignment for communication with one or more user equipments (UEs).

14. The method of claim 1, wherein the determining the first C-band resources used for the FSS comprises:
receiving information identifying the first C-band resources used for the FSS; and
determining the first C-band resources used for the FSS based on the information identifying the first C-band resources used for FSS.

15. The method of claim 14, further comprising:
communicating the allocation of the second C-band resources for the terrestrial BWA network to a base station and/or a user equipment (UE) in the terrestrial BWA network for use in BWA communication between the base station and the UE.

16. The method of claim 1, wherein the determining the first C-band resources used for the FSS is performed by a monitor station located in close geographic proximity to an FSS receiver.

17. The method of claim 1, wherein the determining the first C-band resources used for the FSS is performed by a user equipment (UE).

18. The method of claim 17, further comprising:
transmitting information from the UE to a base station in the terrestrial BWA network based on the first C-band resources used for the FSS.

19. A wireless electronic device configured to perform the method of claim 1.

20. A computer program product comprising:
a non-transitory computer readable storage medium comprising computer readable program code therein that when executed by a processor causes the processor to perform the method of claim 1.

21. A wireless electronic device comprising:
a processor configured to perform operations comprising:
determining first C-band resources used for a Fixed Satellite Service (FSS); and
determining an allocation of second C-band resources for a terrestrial Broadband Wireless Access (BWA) network based on both channel state information associated with the terrestrial BWA network and the first C-band resources used for the FSS.

22. The wireless electronic device of claim 21, wherein the first C-band resources used for the FSS comprise a first FSS downlink data and a second FSS downlink data separated by a time gap between the first FSS downlink data and the second FSS downlink data, and wherein the determining the allocation of the second C-band resources for the terrestrial BWA network comprises:
allocating the second C-band resources for the terrestrial BWA network for BWA transmission during the time gap between the first FSS downlink data and the second FSS downlink data.

23. The wireless electronic device of claim 22, wherein the allocating the second C-band resources for the terrestrial BWA network comprises identifying the time gap between the first FSS downlink data and the second FSS downlink data, the wireless electronic device further comprising:
a transceiver configured to transmit BWA data during the time gap that was identified.

24. The wireless electronic device of claim 21, wherein the processor is further configured to perform operations comprising:
performing Forward Error Correction (FEC) on FSS downlink data to correct errors in the FSS downlink data caused by transmissions on the second C-band resources that overlap in time with the FSS downlink data.

25. The wireless electronic device of claim 21, wherein the first C-band resources used for the FSS comprise FSS downlink data distributed across a first C-band channel and a second C-band channel, and wherein the determining the allocation of the second C-band resources for the terrestrial BWA network comprises:
allocating the second C-band resources for the terrestrial BWA network in a guard band that is between the first C-band channel and the second C-band channel.

26. The wireless electronic device of claim 21, wherein the first C-band resources used for the FSS comprise a plurality of first FSS sub-bands used by the FSS, wherein the determining the allocation of the second C-band resources for the terrestrial BWA network comprises:
allocating a second FSS sub-band for communication between a base station and/or a user equipment (UE) in the terrestrial BWA network, and
wherein the second FSS sub-band is different from ones of the plurality of the first FSS sub-bands.

27. The wireless electronic device of claim 21, further comprising:
a transceiver configured to perform operations comprising:
receiving, from a monitor station, time slot information and/or frequency information associated with transmissions in the terrestrial BWA network; and
sending information associated with the time slot information and/or frequency information to a base station in the terrestrial BWA network for allocating for communication with one or more user equipments (UEs).

28. The wireless electronic device of claim 27, wherein the processor is further configured to perform operations comprising:
determining available time slots and/or available frequency channels based on the time slot information and/or the frequency information.
